(19) United States
(12) Patent Application Publication
(10) Pub. No.: US 2024/0331340 A1
(43) Pub. Date: Oct. 3, 2024

(54) IMAGE PROCESSING DEVICE AND IMAGE PROCESSING METHOD THEREFOR

(71) Applicant: HANWHA VISION CO., LTD., Seongnam-si (KR)

(72) Inventor: Sung Hyun YOON, Seongnam-si (KR)

(73) Assignee: HANWHA VISION CO., LTD., Seongnam-si (KR)

(21) Appl. No.: 18/738,554

(22) Filed: Jun. 10, 2024

Related U.S. Application Data
(63) Continuation of application No. PCT/KR2022/011036, filed on Jul. 27, 2022.

(30) Foreign Application Priority Data
Jan. 19, 2022 (KR) 10-2022-0007985
Jun. 3, 2022 (KR) 10-2022-0068512

(51) Int. Cl. G06V 10/25; G06T 7/20; G06T 7/62; G06T 7/70; H04N 19/124; H04N 19/172

(52) U.S. Cl. CPC G06V 10/25; G06T 7/20; G06T 7/62; G06T 7/70; H04N 19/124; H04N 19/172; G06V 2201/07

(57) ABSTRACT

An image processing device including a processor configured to: detect object data of an object from first image frames, among image frames input from an image sensor, at predetermined intervals according to an object detection rate which is lower than a frame rate of the image sensor; estimate, based on the object data of the first image frames, object data from second image frames other than the first image frames among the image frames; and encode the image frames at an encoding frame rate that is equal to the frame rate of the image sensor, based on the object data.

### CROSS REFERENCE TO RELATED APPLICATION(S)

This application is based on and claims priority to International Application No. PCT/KR2022/011036, filed on Jul. 27, 2022, in the Korean Intellectual Property Receiving Office, which is based on and claims priority to Korean Patent Applications No. 10-2022-0068512, filed on Jun. 3, 2022 and No. 10-2022-0007985, filed on Jan. 19, 2022, in the Korean Intellectual Property Office, the disclosures of which are incorporated by reference herein in their entireties.

### BACKGROUND

### 1. Field

The present disclosure relates to an image processing device and an image processing method therefor.

### 2. Description of Related Art

Recently, the number of cameras installed inside, outside, or on the streets of buildings has been increasing for various purposes such as crime prevention, security, and store management.

### SUMMARY

According to an aspect of the disclosure, an image processing method of an image processing device may include: detecting object data of an object from first image frames, among image frames input from an image sensor, at predetermined intervals according to an object detection rate which is lower than a frame rate of the image sensor; estimating object data from second image frames other than the first image frames among the image frames, based on object data of the first image frames; and encoding the image frames at an encoding frame rate that is equal to the frame rate of the image sensor, based on the object data.

The object data may include: a position of a region of interest including the object; and a size of the region of interest.

The estimating of the object data may include: based on a determination that a timestamp of a current image frame does not correspond with a timestamp of the detected object data, estimating object data of the current image frame, based on at least one previous object data detected before the current image frame.

The estimating of the object data may further include: based on the at least one previous object data detected before the current image frame, determining a past object move vector according to a movement of the object, and when the object is moving according to the past object move vector, estimating object data of the current image frame, based on the past object move vector and a weight parameter based on a time difference between the current image frame and the at least one previous object data detected before the current image frame.

The estimating of the object may further include: based on the at least one previous object data detected before the current image frame, determining a past object move vector according to a movement of the object, and when the object is not moving according to the past object move vector, estimating object data of the current image frame, based on the at least one previous object data detected before the current image frame.

The encoding the image frames may include controlling a quantization parameter and a bit rate.

The encoding the image frames may further include: setting a first quantization parameter value of a region of non-interest to be higher than a second quantization parameter value of the region of interest; determining a first bit rate based on an object ratio, which is a ratio of the size of the region of interest to a size of an image frame, and a second bit rate based on a bit rate increase amount according to a change in the quantization parameter; and compressing the image frames according to the quantization parameter and the second bit rate.

The first bit rate may be a predetermined ratio of a target bit rate according to the object ratio.

The bit rate increase amount may be a predetermined ratio of a target bit rate according to at least one of image quality and object mobility.

The object ratio may be a ratio of the size of the region of interest of a moving object to the size of the image frame.

According to an aspect of the disclosure, an image processing device may include a processor configured to: detect object data of an object from first image frames, among image frames input from an image sensor, at predetermined intervals according to an object detection rate which is lower than a frame rate of the image sensor; estimate, based on the object data of the first image frames, object data from second image frames other than the first image frames among the image frames; and encode the image frames at an encoding frame rate that is equal to the frame rate of the image sensor, based on the object data.

The object data may include a position of a region including the object; and a size of the region of interest.

The processor may be further configured to: based on a determination that a timestamp of a current image frame does not correspond with a timestamp of the object data, estimate object data of the current image frame, based on at least one previous object data detected before the current image frame.

The processor may be further configured to: based on the at least one previous object data detected before the current image frame, determine a past object move vector according to a movement of the object, and when the object is moving according to the past object move vector, estimate the object data of the current image frame, based on the past object move vector and a weight parameter based on a time difference between the current image frame and the at least one previous object data detected before the current image frame.

The processor may be further configured to: based on the at least one object data detected before the current image frame, determine a past object move vector according to a movement of the object, and when the object is not moving according to the past object move vector, estimate the object data of the current image frame, based the at least one object data detected before the current image frame.

The processor may be further configured to: encode the image frames based on a determined quantization parameter and bit rate.

The processor may be further configured to: set a first quantization parameter value for a region of non-interest to be higher than a second quantization parameter value for the region of interest, determine a first bit rate based on an object ratio, which is a ratio of the size of the region of interest to a size of an image frame, and a second bit rate based on a bit rate increase amount according to a change in the quantization parameter, and compresses the image frames according to the quantization parameter and the second bit rate.

The first bit rate may be a predetermined ratio of a target bit rate according to the object ratio.

The bit rate increase amount may be a predetermined ratio of a target bit rate set by a user according to at least one of image quality and object mobility.

The object ratio may be a ratio of the size of the region of interest of a moving object to the size of the image frame.

According to an aspect of the disclosure, an image processing device may include: an image sensor; a memory storing instructions; and a processor configured to execute the instructions to: input image frames from the image sensor at a predetermined frame rate, detect object data of an object from first image frames, among the image frames, at predetermined intervals according to an object detection rate which is lower than the predetermined frame rate, estimate, based on the object data of the first image frames, object data from a current image frame which is not a first image frame, and encode the image frames at an encoding frame rate that is equal to the predetermined frame rate, based on the object data, wherein, to estimate the object data from the current image frame, the processor is configured to execute the instructions to: based on a change of at least one previous object data before the current image frame, determine a movement of the object; and estimate the object data of the current image frame, and wherein, based on a determination that the object is moving, the object data of the current image is estimated based on the determined movement, a time difference between the current image frame, and the at least one previous object data detected before the current image frame, and based on a determination that the object is moving, the object data of the current image is estimated based on the at least one object data before the current image frame.

The processor may be further configured to execute the instructions to: determine a quantization of the image frames based on setting a first quantization parameter for a region of non-interest to be higher than a second quantization parameter for a region of interest including the object, determine a first bit rate based on an object ratio, which is a ratio of the size of the region of interest to a size of the image frame, and a second bit rate based on a bit rate increase amount according to the determined quantization, and compress the image frames according to the quantization parameter and the second bit rate.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram schematically illustrating a security system according to an embodiment;

FIGS. 2 and 3 are diagrams schematically illustrating the configuration of an image processing device according to an embodiment;

FIG. 4 is a diagram describing detection of object data according to an embodiment;

FIG. 5 is a diagram illustrating estimation of object data of an image processing device according to an embodiment; and

FIG. 6 and FIG. 7 are flowcharts schematically describing an image processing method of an image processing device, according to an embodiment.

### DETAILED DESCRIPTION

An image processing device according to an embodiment of the present disclosure includes region of information (ROI) detection unit that detects object data from first image frames at regular intervals according to an object detection rate which is lower than a frame rate of an image sensor, among image frames input from the image sensor; an ROI estimation unit that estimates, based on object data of the first image frames, object data from second image frames other than the first image frames among the image frames; and an encoder that encodes the image frames at an encoding frame rate that is equal to the frame rate of the image sensor, based on the object data.

The following description merely exemplifies the principles of the present disclosure. The use of the conditional terms and embodiments presented in the present specification are intended only to make the concept of the present disclosure understood, and they may not limit the embodiments and conditions mentioned in the specification. In addition, all the detailed description on the principles, viewpoints and embodiments and particular embodiments of the present disclosure should be understood to include structural and functional equivalents. The equivalents may include currently known equivalents and those to be developed in the future, that is, all devices invented to perform the same function, regardless of their structures.

Therefore, functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared. The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may also be included therein.

The foregoing objects, features, and advantages will be more apparent from the following detailed description made with reference to the accompanying drawings. In the description of the present disclosure, the detailed description of known techniques which might unnecessarily obscure the subject matter of the present disclosure will be omitted or made in brief.

In the present specification, it is to be understood that the terms such as “including” or “having,” or “comprising”, are intended to indicate the existence of the features, numbers, operations, components, parts, or combinations thereof disclosed in the specification, and are not intended to preclude the possibility that one or more other features, numbers, operations, components, parts, or combinations thereof may exist or may be added.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

An ‘image’ according to an embodiment of the present disclosure may be a still image or may include a moving image composed of a plurality of consecutive frames.

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

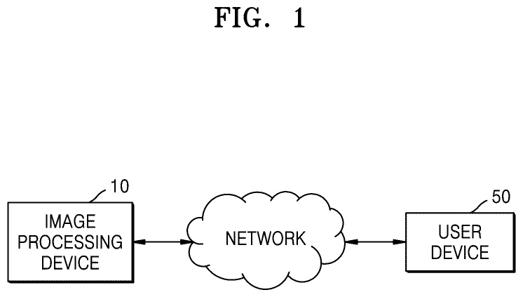

FIG. 1 is a diagram schematically illustrating a security system according to an embodiment.

Referring to FIG. 1, a security system 1 according to an embodiment may include an image processing device 10 and a user device 50. The image processing device 10 and the user device 50 may be connected through a wired and/or wireless network.

A network may include a wired network such as local area networks (LANs), wide area networks (WANs), metropolitan area networks (MANs), and integrated service digital networks (ISDNs), etc. . . . Alternatively or additionally, the network may include a wireless network including wireless Internet such as 3G, 4G (LTE), 5G, Wi-Fi, Wireless Internet such as Wibro, Wimax, etc. . . . Alternatively or additionally, the wireless network may include short-distance communication and short distance networks, such as Bluetooth, radio frequency identification (RFID), Infrared Data Association (IrDA), Ultra Wideband (UWB), ZigBee, Near field communication (NFC), etc. In wireless mobile communication, a communication network may include a component such as a base transceiver station (BTS), a mobile switching center (MSC), a home location register (HLR), an access gateway that enables transmission and reception of wireless packet data, and a packet data serving node (PDSN). The scope of the present disclosure is not limited thereto.

The image processing device 10 may be or may include a camera that obtains images of a surveillance area by photographing the surveillance area. The camera may capture an image of a surveillance area in real time for surveillance or security purposes, and may be provided with one or more cameras. The camera may be placed at a fixed position in a specific place and may be a single fixed camera that has a fixed photographing range, or a PTZ camera with pan/tilt/zoom functions. The camera may be a network camera including a visual camera, thermal camera, special purpose camera, etc.

The user device 50 may monitor information received from the image processing device 10 by using a monitor terminal. The user device 50 may be composed of various devices such as a Digital Video Recorder (DVR), Network Video Recorder (NVR), and a server. In this case, the user device 50 may be installed in government offices, police stations, hospitals, central control centers, central control stations, all-source situation rooms, etc. According to an embodiment, the user device 50 may include a desktop PC, a tablet PC, a slate PC, a laptop computer, a portable terminal such as a smartphone, etc.

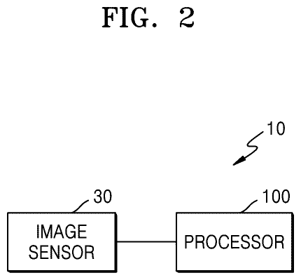

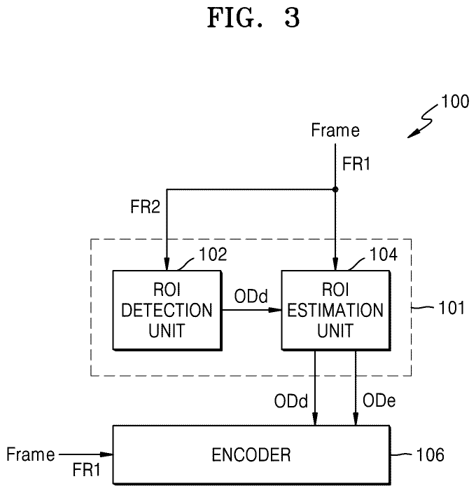

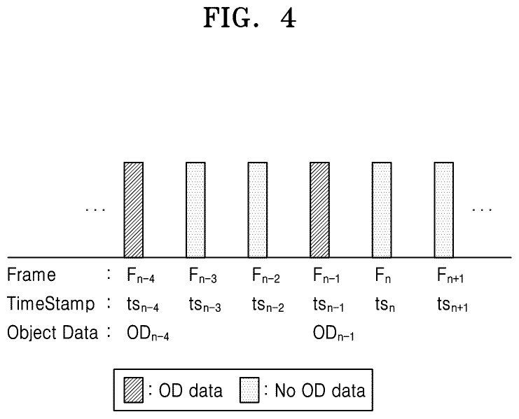

FIG. 2 and FIG. 3 are diagrams schematically illustrating the configuration of an image processing device according to an embodiment. FIG. 4 is a diagram describing detection of object data according to an embodiment.

The image processing device 10 may include an image sensor 30, such as a charge coupled device (CCD) or a complementary metal oxide semiconductor (CMOS) device, and a processor 100. The processor 100 may be implemented using a variety of hardware or/and software components that execute certain functions. For example, the processor 100 may refer to a data processing device that is built into hardware and has a physically structured circuit to perform a function expressed by code or instructions included in a program. Examples of data processing apparatuses built into hardware include a microprocessor, central processing unit (CPU), processor core, multiprocessor, and application-specific integrated (ASIC), field programmable gate array (FPGA), etc., but the scope of the present disclosure is not limited thereto.

Referring to FIG. 3, the processor 100 may include an object data obtaining unit 101 and an encoder 106. The object data acquirer 101 may include an ROI detector 102 and an ROI estimator 104. As illustrated in FIG. 4, the processor 100 may receive a series of image frames from the image sensor 30 at a predetermined frame rate FR1. The processor 100 may generate a timestamp (TimeStamp) in the image frames. The processor 100 may detect object data from image frames at regular intervals according to an object detection rate FR2 among image frames received from the image sensor 30. The object detection rate FR2 may be lower than the frame rate FR1 of the image sensor 30. For example, the frame rate FR1 of the image sensor 30 may be 30 FPS, and the object detection rate FR2 may be 10 FPS.

Here, according to one or more embodiments, at least one of the ROI detector 102, the ROI estimator 104 and the encoder 106 may be implemented by one or more software modules, computer programs, codes or a combination thereof which are stored in an internal memory device of the processor 100 or an external memory device to be executed by the processor 100 to perform corresponding operations or functions described herein. Alternatively or additionally, at least one of the ROI detector 102, the ROI estimator 104 and the encoder 106 may be implemented by at least one of a dedicated processor, a field programmable gate array (FPGA) and an application specific integrated circuit (ASIC) combined with corresponding software or firmware to perform the corresponding operations or functions described herein.

The object data acquirer 101 may obtain object data OD from image frames to be encoded in an encoder 206.

The ROI detector 102 may detect object data from image frames input at regular intervals according to the object detection rate FR2 among image frames input from the image sensor 30. The ROI detector 102 may detect an object in an image frame and detect a region of interest (ROI) by setting an area including the detected object. The ROI detector 102 may detect objects from image frames using artificial intelligence (AI) technology. A region of interest may be at least a portion of an image frame. The ROI detector 102 may detect one or more objects in an image frame and set one or more regions of interest. The ROI detector 102 may detect a position of a region of interest and a size of the region of interest as object data of an object. Hereinafter, object data of an object detected from an image frame by the ROI detector 102 according to an object detection algorithm is referred to as first object data ODd.

The first object data ODd may include the position of a region of interest ROI, the size of the region of interest ROI, the type of object, and a timestamp. The position of the region of interest ROI may be a top left corner position and/or a center position of the region of interest ROI. The size of the region of interest ROI may include a width and a height of the region of interest ROI. The type of object may be information indicating whether the detected object is a moving object or a stationary object. The first object data ODd may include object data of one or more objects. The first object data ODd may include the number of objects.

The ROI detector 102 may calculate an object move vector (OMV) from the first object data of the same object detected in each pair of image frames input at predetermined time intervals according to an object detection rate. The ROI detector 102 may calculate the object move vector (OMV) and a size of the object move vector (OMV). The object move vector (OMV) may be a vector connecting center positions P of regions of interest detected in a pair of image frames.

$$\begin{matrix}{OMV}_{ji} = \vec{{P}_{j} {P}_{i}} \\ {OMV}_{ji} {Size}_{horizontal} = \vert {x}_{j} - {x}_{i} \vert {OMV}_{ji} {Size}_{vertical} = \vert {y}_{j} - {y}_{i} \vert\end{matrix} \qquad Equation ( 1 )$$

In Equation (1), i may represent an image frame that is earlier in time among a pair of image frames, and j may represent an image frame that is later in time among the pair of image frames. The ROI detector 102 may calculate an object move vector (OMV) from first object data of the image frame i and first object data of the image frame j, as shown in Equation (1). Here, the size of the object move vector (OMV) may include a horizontal size Size_{horizontal} and a vertical size Size_{vertical}. The horizontal size Size_{horizontal} may be an absolute value of a difference between the x-axis values of the center positions P of the region of interest. The vertical size Size_{vertical} may be an absolute value of a difference between the y-axis values of the center positions P of the region of interest.

The ROI detector 102 may determine an object to be a moving object if the size of the object move vector (OMV) is greater than a threshold value. The threshold value may be set as a predetermined ratio of the size of the region of interest detected in a later image frame in time among the pair of image frames used to calculate the object move vector (OMV). For example, if the threshold value is set to 25% of the size of the region of interest, and the horizontal size Size_{horizontal} and the vertical size Size_{vertical} of the object move vector OMVji, which are respectively calculated from the center position of the region of interest detected from the i image frame and the center position of the region of interest detected from the j image frame, are greater than 25% of the size of the region of interest detected from the j image frame, the ROI detector 102 may determine the object as a moving object.

FIG. 4 illustrates timestamps ( . . . , tsn−4, tsn−3, tsn−2, tsn−1, tsn, tsn+1, . . . ) of image frames ( . . . , Fn−4, Fn−3, Fn−2, Fn−1, Fn, Fn+1, . . . ) input at 30 FPS and first object data ( . . . , ODn−4, ODn−1, . . . ) detected from image frames ( . . . , Fn−4, Fn−1, . . . ) input at 10 FPS. FIG. 4 illustrates frames in which object data is detected by the ROI detector 102 and frames in which no object data is detected.

The ROI estimator 104 may receive image frames from the image sensor 30 and receive the first object data ODd from the ROI detector 102.

The ROI estimator 104 may estimate object data from image frames other than those from which the first object data is detected, among the image frames input by the image sensor 30. For example, the ROI estimator 104 may estimate object data from the image frames ( . . . , Fn−3, Fn−2, Fn, Fn+1, . . . ) from which object data ( . . . , ODn−4, ODn−1, . . . ) is not detected, from among the image frames ( . . . , Fn−4, Fn−3, Fn−2, Fn−1, Fn, Fn+1, . . . ) illustrated in FIG. 4.

The ROI estimator 104 may estimate object data from an image frame based on at least one first object data. The ROI estimator 104 may determine whether a timestamp of the currently input image frame (hereinafter referred to as ‘current image frame’) and a timestamp of the first object data are the same as each other. In an embodiment, the ROI estimator 104 may compare the timestamp of the current image frame with the timestamp of the first object data input from the ROI detector 102, and if the timestamps are not the same, the ROI estimator 104 may estimate the object data from the current image frame. The ROI estimator 104 may estimate object data from the current image based on at least one first object data (hereinafter referred to as ‘previous first object data’) detected from image frames (previous image frames) before the current image frame. Hereinafter, the object data estimated by the ROI estimator 104 may be distinguished from the first object data ODd and referred to as second object data ODe.

When a past object move vector (Past OMV) exists, the ROI estimator 104 may estimate object data from the current image frame based on the past object move vector (Past OMV) and a weight TW. The existence of a past object move vector (Past OMV) may refer to a case where there is a pair of previous image frames, from which the first object data was detected, before the current image frame. The past object move vector (Past OMV) may be defined as the past object move vector (OMV) closest to the current image frame. The weight TW may be a value reflecting a time difference between the current image frame and the previous image frames. That is, the weight TW may be a value reflecting a time difference between the current image frame and the previous detected object data.

$$\begin{matrix}{OMV}_{ji} = \vec{{P}_{j} {P}_{i}} \\ {OMT}_{{S}_{ji}} = {t}_{{s}_{i}} , {OMT}_{{e}_{ji}} = {t}_{{s}_{j}} \\ {TW}_{k} = ( {t}_{{S}_{k}} - {t}_{{S}_{j}} ) / ( {OMT}_{{e}_{ji}} - {OMT}_{{S}_{ji}} ) \\ {P}_{k} ( x , y ) = ( {OMV}_{ij} * {TW}_{k} ) + {P}_{j} ( x , y ) \\ {width}_{k} = {width}_{j} \\ {height}_{k} = {height}_{j}\end{matrix} \qquad Equation ( 2 )$$

In Equation (2), i may represent a first previous image frame that is earlier in time among a pair of previous image frames, and j may represent a second previous image frame that is later in time among the pair of previous image frames. For instance, the second previous image frame j may be closer to the current image frame, which may be represented by k. OMVⱼᵢ may be a past object move vector (past OMV) for the current image frame. OMTe and OMTs may represent an end time and a start time of the past object move vector OMVⱼᵢ, respectively.

When a past object move vector (Past OMV) exists for the current image frame, the ROI estimator 104 may estimate object data from the current image frame, as shown in Equation (2). The estimated object data may be a position Pₖ of a region of interest and a size of the region of interest, width/height (widthₖ/heightₖ). The position Pₖ of the region of interest may be a value obtained by adding the product of the object move vector OMVⱼᵢ and the weight TWₖ to the position Pⱼ of the second previous image frame. The weight TWₖ may be a value obtained by dividing a difference between a timestamp tsₖ of the current image frame and a timestamp tsᵢ of the first previous image frame by a difference between a start time OMTeᵢⱼ and an end time OMTsᵢⱼ of the past object move vector OMVⱼᵢ. The width widthₖ of the region of interest may be the width widthⱼ of the second previous image frame. The height heightₖ of the region of interest may be the height widthⱼ of the second previous image frame.

When a past object move vector (Past OMV) does not exist, the ROI estimator 104 may estimate object data from the current image frame based on previous first object data. The absence of a past object move vector (Past OMV) may refer to a case where there is only one previous first object data, which may mean that there is one previous image frame in which the first object data was detected before the current image frame.

When there is no past object move vector (Past OMV) for the current image frame, the ROI estimator 104 may estimate object data from the current image frame, as shown in Equation (3) below. The estimated object data may be the position Pₖ of the region of interest and the size of the region of interest, width/height widthₖ/heightₖ. The position Pₖ and width/height widthₖ/heightₖ of the region of interest in the current image frame may be a position Pⱼ and the width/height widthⱼ/heightⱼ of the region of interest in the second previous image frame.

$$\begin{matrix}{P}_{k} ( x , y ) = {P}_{j} ( x , y ) \\ {width}_{k} = {width}_{j} \\ {height}_{k} = {height}_{j}\end{matrix} \qquad Equation ( 3 )$$

The ROI estimator 104 may provide the first object data ODd and the second object data ODe from the ROI detector 102, to the encoder 106.

The encoder 106 may compress and encode image frames according to an encoding frame rate. The encoding frame rate may be the same as the frame rate FR1 of the image sensor 30. The encoder 106 may control bandwidth by controlling a quantization parameter (QP) and/or a bit rate and encoding image frames.

The encoder 106 may set a QP value based on the object data ODd, ODe of image frames. The encoder 106 may set different QP values for a region of interest and a region of non-interest. The region of non-interest may be a region other than the region of interest. The encoder 106 may set a QP value to improve the relative image quality of the region of interest. The encoder 106 may set the quality of the region of interest to be higher than that of the region of non-interest by setting a higher QP value for the region of non-interest than a QP value for the region of interest.

In an embodiment, the encoder 106 may maintain the QP value of the region of interest as a reference QP value set by the user and set the QP value of the region of non-interest to a value that is increased by a predetermined amount from the reference QP value. For example, the encoder 106 may maintain the QP value of the region of interest as the reference QP value and set the QP value of the region of non-interest to a value that is greater than the reference QP value by a predetermined value. In an embodiment, the increase amount in the QP value may be selected as one of predetermined high (H)/medium (M)/low (L) values depending on the quality level. By setting the QP value of the region of non-interest to be larger than the QP value of the interest area, the bandwidth may be reduced by increasing the compression rate of the region of non-interest.

In another embodiment, the encoder 106 may maintain the QP value of the region of non-interest as the reference QP value set by the user and set the QP value of the region of interest to a value reduced by a predetermined amount from the reference QP value.

The encoder 106 may control the bit rate based on object data. In an embodiment, the encoder 106 may control the bit rate on an hourly basis. For example, the encoder 106 may control the bit rate based on object data of image frames for a predetermined period (e.g., 1 second). In another embodiment, the encoder 106 may control the bit rate on an image frame basis. For example, the encoder 106 may control the bit rate based on object data for each image frame.

The encoder 106 may calculate the first bit rate as a predetermined percentage (%) of a target bit rate based on an object ratio. The object ratio may be a ratio of the size of the region of interest to the size of the image frame. In an embodiment, the size of the region of interest may be the size of the region of interest for a moving object. There may be one or more moving objects, and the size of the region of interest for calculating the object ratio may be a sum of the sizes of the regions of interest of all moving objects. A target bit rate Targetbps may be a user-set value. Below is an example of a first bit rate Targetbps′ according to an object ratio (Ratio). For example, if the size of the region of interest compared to the image frame size is less than 3%, the first bit rate Targetbps′ may be determined to be 20% of the target bit rate Targetbps′.
If Ratio <3 [%] then Targetbps′=20 [%] of Targetbps,
Else if Ratio <11 [%] then Targetbps′=30 [%] of Targetbps,
Else if Ratio <21 [%] then Targetbps′=40 [%] of Targetbps,
Else if Ratio <31 [%] then Targetbps′=50 [%] of Targetbps,
Else if Ratio <41 [%] then Targetbps′=60 [%] of Targetbps,
Else if Ratio <51 [%] then Targetbps′=70 [%] of Targetbps,
Else Targetbps′=100 [%] of Targetbps

The encoder 106 may control the bit rate by increasing the target bit rate by calculating a bit rate increase amount. The encoder 106 may calculate the bit rate increase amount based on at least one of image quality and object mobility. A bit rate increase amount AddBps may be determined as a predetermined ratio (%) of the target bit rate Targetbps.

In an embodiment, the encoder 106 may set the bit rate increase amount AddBps according to image quality. For example, the bit rate increase amount AddBps may be selected as one of predetermined high (H)/medium (M)/low (L) values such as 0%/10%/20% of the target bit rate Targetbps depending on the quality level.

According to an embodiment, the bit rate increase amount AddBps may be set according to object mobility. Object mobility may be determined based on the ratio of moving objects among all objects in one image frame or image frames during a predetermined period. For example, the bit rate increase amount AddBps may be determined as 0% of the target bit rate Target bps if the object is a stationary object (non-moving object) or the ratio of stationary objects is high, and if the object is a moving object or the ratio of moving objects is high, the bit rate increase amount AddBps may be determined as 10% of the target bit rate Target bps. Deterioration of image quality due to moving objects may be prevented by setting the bit rate increase amount AddBps according to the object mobility.

In an embodiment, the encoder 106 may calculate the bit rate increase amount based on one of image quality and object mobility. In an embodiment, the encoder 106 may sum the bit rate increase amount calculated based on each of image quality and object mobility. In an embodiment, the encoder 106 may calculate one of or an average of the bit rate increase amounts calculated based on each of image quality and object mobility as the bit rate increase amount.

The encoder 106 may control the bit rate by increasing or decreasing the QP value according to the QP increase amount or decrease amount. The encoder 106 may calculate a QP increase/decrease amount based on at least one of image quality and object mobility. The QP increase/decrease amount may be set within a range from a minimum QP value to a maximum QP value. Image quality may be controlled by bit rate control using bit rate increase amount and/or QP increase/decrease amount.

The encoder 106 may set a second bit rate, which is a sum of the first bit rate Targetbps' and the bit rate increase amount AddBps, as a final bit rate. The first bit rate Targetbps' and the bit rate increase amount AddBps may be calculated based on the target bit rate. The encoder 106 may set the second bit rate which is the first bit rate Targetbps' increased or decreased according to the amount of a QP increase or decrease, as the final bit rate.

The encoder 106 may compress and encode image frames by using the set QP value and/or the final bit rate value.

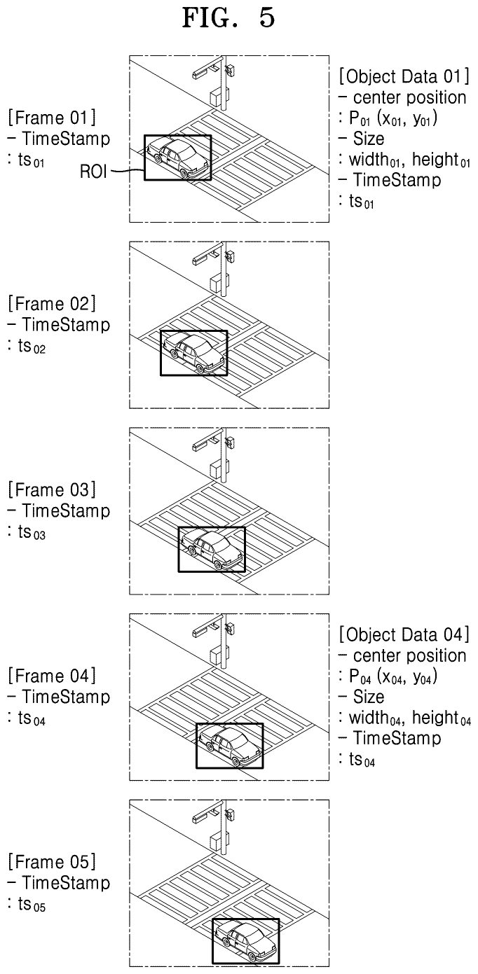

FIG. 5 is a diagram illustrating estimation of object data of an image processing device according to an embodiment.

As illustrated in FIG. 5, first to fifth image frames Frame01, Frame02, Frame03, Frame04, Frame05 may be sequentially generated from the image sensor 30 according to the frame rate FR1 and input to the processor 100.

The ROI detector 102 may detect object data from image frames at regular intervals according to the object detection rate FR2 among the first to fifth image frames Frame01, Frame02, Frame03, Frame04, and Frame05. For example, the ROI detector 102 may detect object data OD01 and object data OD04 from the first image frame Frame01 and the fourth image frame Frame04, respectively. The object data OD01 of the first image frame Frame01 may include a center position P₀₁ of a region of interest ROI, a width/height width₀₁/height₀₁ as size information, and a timestamp ts₀₁ of a region of interest ROI. The object data OD04 of the fourth image frame Frame04 may include a center position P₀₄, a width/height width₀₄/height₀₄, and a timestamp ts₀₄ of a region of interest ROI.

The ROI estimator 104 may estimate object data of the second image frame Frame02, the third image frame Frame03, and the fifth image frame Frame05 based on the object data OD01 of the first image frame Frame01 and the object data OD04 of the fourth image frame Frame04, generated by the ROI detector 102. The ROI estimator 104 may provide detected object data ODd (first object data) and estimated object data ODe (second object data) to the encoder 106.

When the first image frame Frame01 is input as the current image frame, the ROI estimator 104 may compare the timestamp ts₀₁ of the first image frame Frame01 with the time stamp ts₀₁ of the object data OD01 of the first image frame Frame01 provided from the ROI detector 102. Since the timestamps ts₀₁ are the same, the ROI estimator 104 may transmit the object data OD01 of the first image frame Frame01 from the ROI detector 102 to the encoder 106.

When the second image frame Frame02 is input as the current image frame, the ROI estimator 104 may compare a timestamp ts₀₂ of the second image frame Frame02 with the time stamp ts₀₁ of the object data OD01 of the first image frame Frame01 provided from the ROI detector 102. Since the timestamp ts₀₂ is different from the timestamp ts₀₁, the ROI estimator 104 may estimate object data from the second image frame Frame02. Since there is only the object data OD01 of the first image frame Frame01 before the second image frame Frame02, the ROI estimator 104 may estimate object data OD02 of the second image frame Frame02 according to Equation (3). The ROI estimator 104 may estimate the object data OD02 of the third image frame Frame03 similarly to the second image frame Frame02. Equation (4) below is a result of estimating the object data OD02 of the second image frame Frame02 and object data OD03 of the third image frame Frame03 according to Equation (3).

$$\begin{matrix}{P}_{02} ( x , y ) = {P}_{03} ( x , y ) = {P}_{01} ( x , y ) \\ {width}_{02} = {width}_{03} = {width}_{01} \\ {height}_{02} = {height}_{03} = {height}_{01}\end{matrix} \qquad Equation ( 4 )$$

When the fourth image frame Frame04 is input as the current image frame, the ROI estimator 104 may compare the timestamp ts₀₄ of the fourth image frame Frame04 with the time stamp ts₀₄ of the object data OD04 of the fourth image frame Frame04 provided from the ROI detector 102. Since the timestamps ts₀₄ are the same, the ROI estimator 104 may transmit the object data OD04 of the fourth image frame Frame04 from the ROI detector 102 to the encoder 106.

When the fifth image frame Frame05 is input as the current image frame, the ROI estimator 104 may compare a timestamp ts₀₅ of the fifth image frame Frame05 with the timestamp ts₀₄ of the object data OD04 of the fourth image frame Frame04. Since the timestamp ts₀₅ is different from the timestamp ts₀₄, the ROI estimator 104 may estimate object data from the fifth image frame Frame05. As there is a past object move vector OMV₄₁ generated based on the object data OD01 of the first image frame Frame01 and the object data OD04 of the fourth image frame Frame04 before the fifth image frame Frame05, the ROI estimator 104 may estimate object data OD05 of the fifth image frame Frame05 according to Equation (3). The ROI estimator 104 may estimate object data OD06 of the sixth image frame Frame06 similar to the fifth image frame Frame05. Equation (5) below is a result of estimating the object data OD05 of the fifth image frame Frame05 and the object data OD06 of the sixth image frame Frame06 according to Equation (3).

$$\begin{matrix}{OMV}_{41} = \vec{{P}_{4} {P}_{1}} \\ {OMT}_{{S}_{41}} = {t}_{{s}_{01}} , {OMT}_{{e}_{41}} = {t}_{{s}_{04}} \\ {TW}_{05} = ( {t}_{{S}_{05}} - {t}_{{S}_{04}} ) / ( {OMT}_{{e}_{41}} - {OMT}_{{S}_{41}} ) \\ {TW}_{06} = ( {t}_{{S}_{06}} - {t}_{{S}_{04}} ) / ( {OMT}_{{e}_{41}} - {OMT}_{{S}_{41}} )\end{matrix} \qquad Equation ( 5 )$$

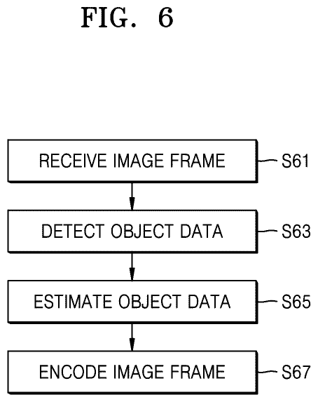

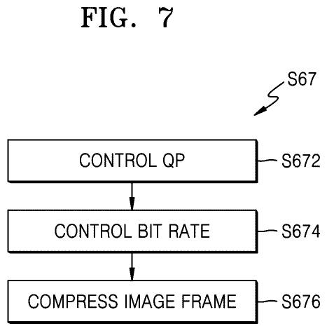

FIGS. 6 and 7 are flowcharts schematically describing an image processing method of an image processing device, according to an embodiment. Hereinafter, description of the details, which are redundant with that of the details described with reference to FIGS. 1 to 5 will be omitted.

The image processing device 10 may receive a series of image frames from the image sensor 30 according to the frame rate of the image sensor 30 (S61). The image processing device 10 may generate a timestamp of an image frame.

The image processing device 10 may detect object data from image frames at regular intervals according to the object detection rate among the received image frames (S63). The object detection rate may be lower than the frame rate of the image sensor 30. The image processing device 10 may detect at least one object from an image frame, set a region of interest ROI including the object, and detect first object data. In an embodiment, the image processing device 10 may detect an object from an image frame by using artificial intelligence (AI) technology.

The first object data may include a position and a size of the region of interest ROI. The position of the region of interest ROI may be a top left vertex or a center of the region of interest ROI. The size of the region of interest ROI may include a width and a height of the region of interest ROI. The first object data may further include a timestamp of the image frame from which the object was detected, the degree of movement of the object, and the number of objects. The image processing device 10 may detect the degree of movement of the object by determining whether the object is a moving object based on an object move vector (OMV).

The image processing device 10 may estimate object data from image frames from which object data is not detected among the received image frames (S65). If the timestamp of the current image frame input from the image sensor 30 is different from the timestamp of the first object data, the image processing device 10 may estimate object data from the current image frame based on at least one previous first object data.

When a past object move vector (Past OMV) exists, the image processing device 10 may estimate object data from the current image frame based on the past object move vector (Past OMV) and a weight TW (refer to the Equation (2)). When a past object move vector (Past OMV) does not exist, the image processing device 10 may estimate object data from the current image frame based on the previous first object data.

The image processing device 10 may encode image frames input from the image sensor 30 based on the first object data and the estimated object data (second object data) by compressing them at an encoding frame rate (S67). The encoding frame rate may be the same as the frame rate of the image sensor 30.

The image processing device 10 may control bandwidth by encoding image frames by controlling quantization parameters and/or bit rates. The image processing device 10 may control a QP value based on the object data (S672). The image processing device 10 may set a quantization parameter value of a region of non-interest to be higher than a quantization parameter value of a region of interest. The image processing device 10 may control a bit rate value based on object data (S674). The image processing device 10 may calculate a first bit rate based on an object ratio and calculate a bit rate increase amount based on at least one of image quality and object mobility. The image processing device 10 may set a second bit rate, which is a sum of the first bit rate and the bit rate increase amount, as the final bit rate. The image processing device 10 may calculate a QP increase/decrease amount based on at least one of image quality and object mobility. The image processing device 10 may set the second bit rate, which is the first bit rate increased or decreased according to the amount of QP increase or decrease, as a final bit rate. The encoder 106 may compress and encode image frames by using the set QP value and/or the final bit rate value.

When an image processing device detects a motion and determines the motion as an object, an error may occur in failing to detect a motionless object and/or in detection a moving background as an object. The image processing device according to the embodiments of the present disclosure, uses an object detection algorithm to image frames input from an image sensor to detect an object at an object detection rate lower than the frame rate of the image sensor, and detects a moving object based on the object detection data. Accordingly, the image processing device according to the embodiments of the present disclosure, object detection accuracy may be increased and also real-time image processing speed may be increased. Additionally, according to the embodiments of the present disclosure, bandwidth may be effectively controlled by encoding images while controlling quantization parameters and bit rates by using objects and regions of interest.

The image processing method of the image processing device according to the present disclosure may be implemented as computer-readable code on a computer-readable recording medium. Computer-readable recording media include all types of recording devices that store data that can be read by a computer system. Examples of computer-readable recording media include ROM, RAM, CD-ROM, magnetic tape, floppy disk, and optical data storage devices. Additionally, computer-readable recording media can be distributed across computer systems connected to a network, so that computer-readable code can be stored and executed in a distributed manner. And, functional programs, codes, and code segments for implementing the present disclosure can be easily deduced by programmers in the technical field to which the present disclosure pertains.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

1. An image processing method of an image processing device, the image processing method comprising:
detecting object data of an object from first image frames, among image frames input from an image sensor, at predetermined intervals according to an object detection rate which is lower than a frame rate of the image sensor;
estimating object data from second image frames other than the first image frames among the image frames, based on object data of the first image frames; and
encoding the image frames at an encoding frame rate that is equal to the frame rate of the image sensor, based on the object data.

2. The image processing method of claim 1, wherein the object data comprises:
a position of a region of interest comprising the object; and
a size of the region of interest.

3. The image processing method of claim 1, wherein the estimating of the object data comprises:
based on a determination that a timestamp of a current image frame does not correspond with a timestamp of the detected object data, estimating object data of the current image frame, based on at least one previous object data detected before the current image frame.

4. The image processing method of claim 3, wherein the estimating of the object data further comprises:
based on the at least one previous object data detected before the current image frame, determining a past object move vector according to a movement of the object, and
when the object is moving according to the past object move vector, estimating object data of the current image frame, based on the past object move vector and a weight parameter based on a time difference between the current image frame and the at least one previous object data detected before the current image frame.

5. The image processing method of claim 3, wherein the estimating of the object data further comprises:
based on the at least one previous object data detected before the current image frame, determining a past object move vector according to a movement of the object, and
when the object is not moving according to the past object move vector, estimating object data of the current image frame, based on the at least one previous object data detected before the current image frame.

6. The image processing method of claim 2, wherein the encoding the image frames comprises controlling a quantization parameter and a bit rate.

7. The image processing method of claim 6, wherein the encoding the image frames further comprises:
setting a first quantization parameter value of a region of non-interest to be higher than a second quantization parameter value of the region of interest;
determining a first bit rate based on an object ratio, which is a ratio of the size of the region of interest to a size of an image frame, and a second bit rate based on a bit rate increase amount according to a change in the quantization parameter; and
compressing the image frames according to the quantization parameter and the second bit rate.

8. The image processing method of claim 7, wherein the first bit rate is a predetermined ratio of a target bit rate according to the object ratio.

9. The image processing method of claim 7, wherein the bit rate increase amount is a predetermined ratio of a target bit rate according to at least one of image quality and object mobility.

10. (canceled)

11. An image processing device comprising a processor configured to:
detect object data of an object from first image frames, among image frames input from an image sensor, at predetermined intervals according to an object detection rate which is lower than a frame rate of the image sensor;
estimate, based on the object data of the first image frames, object data from second image frames other than the first image frames among the image frames; and
encode the image frames at an encoding frame rate that is equal to the frame rate of the image sensor, based on the object data.

12. The image processing device of claim 11, wherein the object data comprises:
a position of a region of interest comprising the object; and
a size of the region of interest.

13. The image processing device of claim 11, wherein the processor is further configured to:
based on a determination that a timestamp of a current image frame does not correspond with a timestamp of the object data, estimate object data of the current image frame, based on at least one previous object data detected before the current image frame.

14. The image processing device of claim 13, wherein the processor is further configured to:
based on the at least one previous object data detected before the current image frame, determine a past object move vector according to a movement of the object, and
when the object is moving according to the past object move vector, estimate the object data of the current image frame, based on the past object move vector and a weight parameter based on a time difference between the current image frame and the at least one previous object data detected before the current image frame.

15. The image processing device of claim 13, wherein the processor is further configured to:
based on the at least one object data detected before the current image frame, determine a past object move vector according to a movement of the object, and
when the object is not moving according to the past object move vector, estimate the object data of the current image frame, based the at least one object data detected before the current image frame.

16. The image processing device of claim 12, wherein the processor is further configured to:
encode the image frames based on a determined quantization parameter and bit rate.

17. The image processing device of claim 16, wherein the processor is further configured to:
set a first quantization parameter value for a region of non-interest to be higher than a second quantization parameter value for the region of interest,
determine a first bit rate based on an object ratio, which is a ratio of the size of the region of interest to a size of an image frame, and a second bit rate based on a bit rate increase amount according to a change in the quantization parameter, and
compresses the image frames according to the quantization parameter and the second bit rate.

18. The image processing device of claim 17, wherein the first bit rate is a predetermined ratio of a target bit rate according to the object ratio.

19. The image processing device of claim 17, wherein the bit rate increase amount is a predetermined ratio of a target bit rate set by a user according to at least one of image quality and object mobility.

20. (canceled)

21. An image processing device comprising:
an image sensor;
a memory storing instructions; and
a processor configured to execute the instructions to:
input image frames from the image sensor at a predetermined frame rate,
detect object data of an object from first image frames, among the image frames, at predetermined intervals according to an object detection rate which is lower than the predetermined frame rate,
estimate, based on the object data of the first image frames, object data from a current image frame which is not a first image frame, and
encode the image frames at an encoding frame rate that is equal to the predetermined frame rate, based on the object data,
wherein, to estimate the object data from the current image frame, the processor is configured to execute the instructions to:
based on a change of at least one previous object data before the current image frame, determine a movement of the object; and
estimate the object data of the current image frame, and
wherein, based on a determination that the object is moving, the object data of the current image is estimated based on the determined movement, a time difference between the current image frame, and the at least one previous object data detected before the current image frame, and
based on a determination that the object is moving, the object data of the current image is estimated based on the at least one object data before the current image frame.

22. The image processing device of claim 21, wherein the processor is further configured to execute the instructions to:
determine a quantization of the image frames based on setting a first quantization parameter for a region of non-interest to be higher than a second quantization parameter for a region of interest including the object,
determine a first bit rate based on an object ratio, which is a ratio of the size of the region of interest to a size of the image frame, and a second bit rate based on a bit rate increase amount according to the determined quantization, and
compress the image frames according to the determined quantization and the second bit rate.
